(19) United States
(12) Patent Application Publication
(10) Pub. No.: US 2003/0160688 A1
(43) Pub. Date: Aug. 28, 2003

(54) Sounding direction indicator for vehicle

(76) Inventors: Young Hee Kim, Seoul (KR); Woong Ki Cho, Seoul (KR)

Correspondence Address: NIXON & VANDERHYE, PC, 1100 N GLEBE ROAD, 8TH FLOOR, ARLINGTON, VA, 22201-4714, US

(21) Appl. No.: 10/353,084

(22) Filed: Jan. 29, 2003

(30) Foreign Application Priority Data
Feb. 1, 2002 (KR) 2002-0005985

(51) Int. Cl. B60Q 1/00

(52) U.S. Cl. 340/457; 340/460; 340/475

(57) ABSTRACT

With present invention helps you to bring about driver's self-awareness by direction indicating light with voice and special sounds. And it helps to make maximum effect of advertisement. If you hear family's, lover's voice or comfortable and classic music instead of clicking machine sounds, it is helpful for you to reduce traffic accident.

And if there comes out advertisement sounds, drivers can remember it easily by repeating and as a result, advertisement effect will be better.

### BACKGROUND OF THE INVENTION

1. Field of the Invention

The present invention is related to direction indicating light which makes sounds for vehicle.

2. Description of the Prior Art

Generally, direction indicating light is used when you change traffic lane. At this time, it only makes click sounds. At this moment, direction indicating relay makes direction indicating light twinkle and helps driver to notify that switch is turned on or not by clicking sounds.

### SUMMARY OF THE INVENTION

The present invention is relates to direction indicator which makes sounds. The sounds of present indicator can be altered to various sounds by audio chip or recording sounds through external microphone.

### BRIEF DESCRIPTION OF THE DRAWINGS

FIG. 1 is an example of invention operation

FIG. 2 is internal circuit figure of design

FIG. 2-1: LM 2574 HV: Signal which comes toward relay when direction indicator signal is inserted,

OP-AMP OP-AMP amplifies signal and sends it to MICOM (Micro Processer)

SSR SSR circuit has relay function(It turns on/off direction indicator light when signal is inserted.)

FIG. 2-2: MLC 1036 Voice Chip : The present voice chip (sounds chip, sounds Rom) changes signal which is received from MICOM and then loaded to 37080 Sop Rom WAV file saved in Rom to voice.

FIG. 2-3: AT89C 1051: It saves every command program in MICOM

Control part—This control part receives MICOM Signal and saves it in ROM by programmed command.

FIG. 2-4: Speaker Output: It outputs changed voice with speaker.

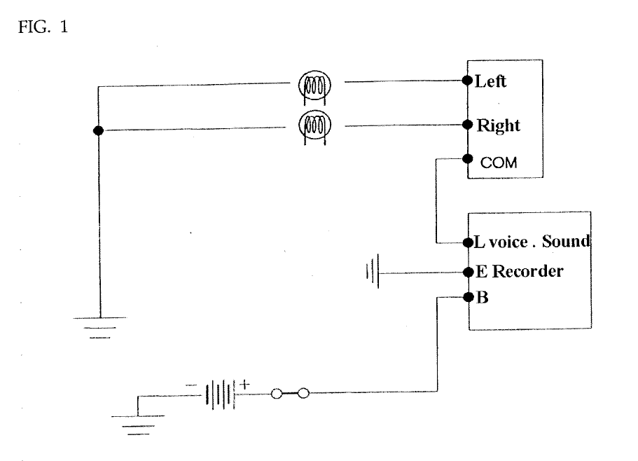

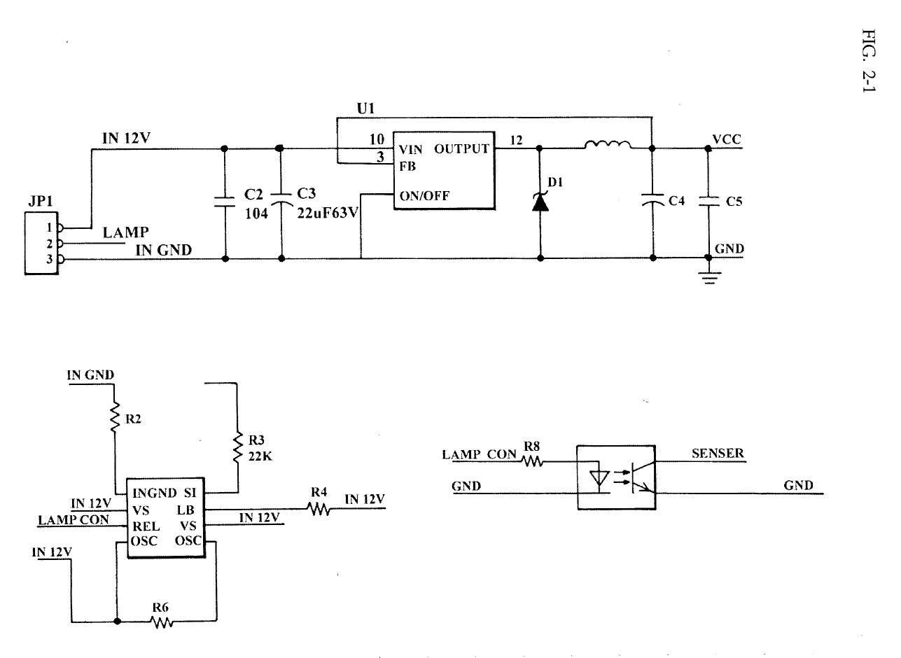

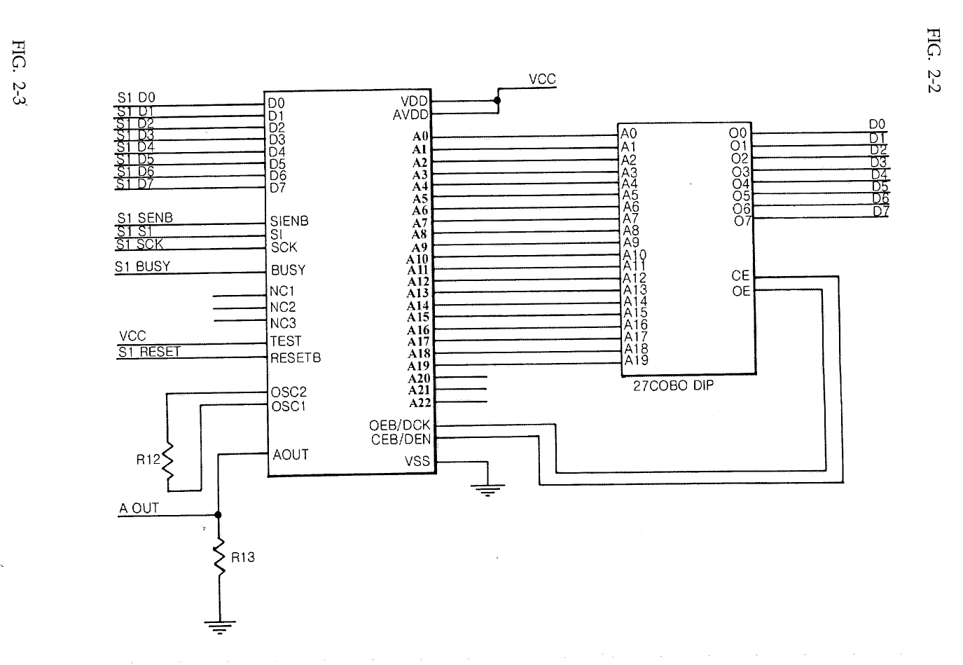

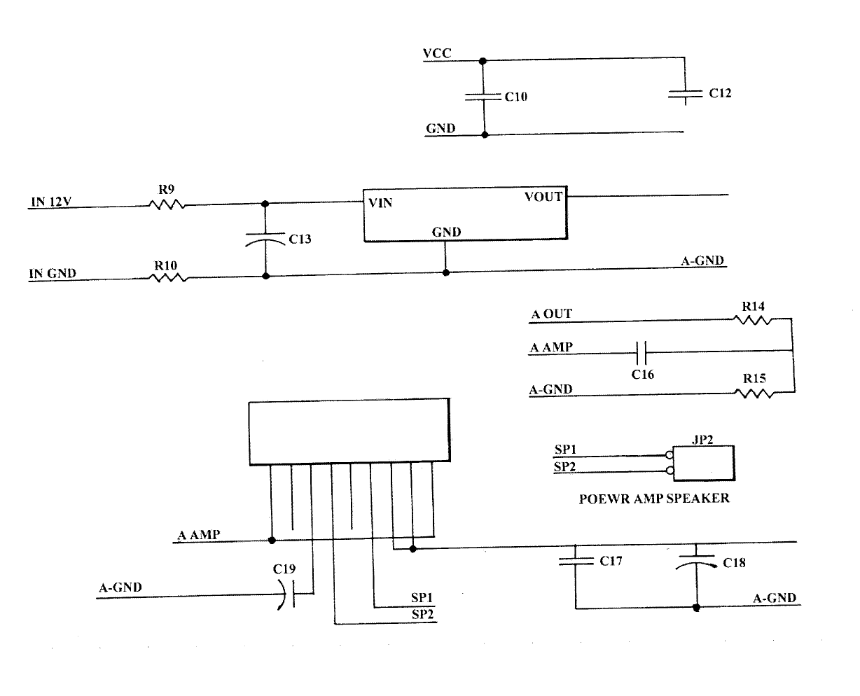

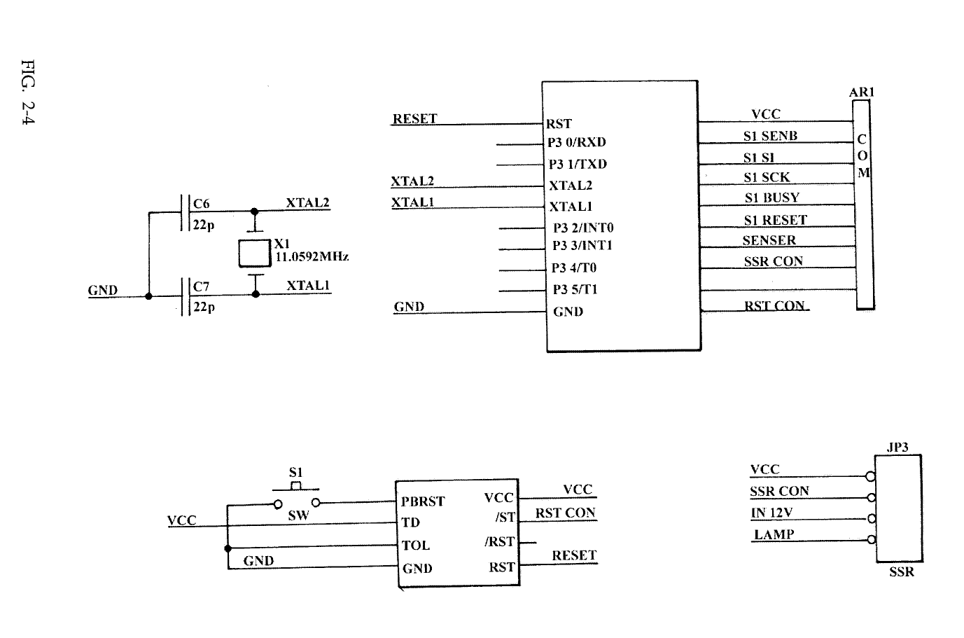

### DETAILED DESCRIPTION OF PREFERRED EMBODIMENTS

Objective of Invention

Technology field where this invention belongs to and existing technology of that field.

The present invention is related to direction indicating light which makes sounds for vehicle.

Generally, direction indicating light is used when you change traffic lane. At this time, it only makes click sounds. At this moment, direction indicating relay makes direction indicating light twinkle and helps driver to notify that switch is turned on or not by clicking sounds.

Technological Problem of the Present Invention

With present invention, you can record your family's or lover's voice which requests safe driving instead of relay sounds of direction indicating light. And you can record special sounds and advertisement and play it in sequence and by section. when you turn on and off the direction indicating light so that you can prevent sleeping driving. Also, if you use direction indicating light sounds as advertisement, it will make maximum effect of advertisement by listening the sounds repeatedly.

Function of direction indicating light relay is materialized inside of sounds-voice recorder-player as circuit.

Composition of the Present Invention

Direction indicating light relay terminal of existing vehicle is attached to the present invented sound player, and this player plays sounds when you turn on right-left, and emergency light. Power is supplied to relay.

And when you turn off direction indicating light and turn it on, recorder will play not from the beginning but where it was.

What is claimed is:

1. Direction indicating light which makes sounds advertisement for vehicle.

2. Direction indicating light which makes safety request with person's voice.

3. Direction indicating light which makes sounds of such as nature, animal, classic music, scriptural phrases and Buddhist scriptures according to favorite of owner.

4. Direction indicating light circuit which makes sounds.
